(19) United States
(12) Patent Application Publication
(10) Pub. No.: US 2017/0230672 A1
(43) Pub. Date: Aug. 10, 2017

(54) METHOD FOR BUFFERING MEDIA TRANSPORT STREAM IN HETEROGENEOUS NETWORK ENVIRONMENT AND IMAGE RECEIVING APPARATUS USING THE SAME

(71) Applicant: Electronics and Telecommunications Research Institute, Daejeon (KR)

(72) Inventors: Kug Jin YUN, Daejeon (KR); Cheol Min KIM, Daejeon (KR); Gwang Soon LEE, Daejeon (KR); Youngil LEE, Daejeon (KR); Jun Geun JEON, Daejeon (KR); Namho HUR, Sejong-si (KR)

(73) Assignee: Electronics and Telecommunications Research Institute, Daejeon (KR)

(21) Appl. No.: 15/424,453

(22) Filed: Feb. 3, 2017

(30) Foreign Application Priority Data
Feb. 5, 2016 (KR) 1020160015291

(51) Int. Cl. H04N 19/172; H04N 19/46; H04N 19/105; H04L 12/26; H04N 19/152

(52) U.S. Cl. CPC H04N 19/172; H04L 43/0858; H04N 19/152; H04N 19/105; H04N 19/46

(57) ABSTRACT

Provided are a method of buffering a media transport stream in a heterogeneous network environment and an image receiving apparatus using the same. A first transport stream corresponding to a first image through a first network is received and a second transport stream corresponding to a second image through a second network is received. The first image corresponding to the first transport stream is buffered based on a preset minimum transmission delay difference, and then the buffered first image and the second image corresponding to the second transport stream are processed.

### CROSS-REFERENCE TO RELATED APPLICATION

This application claims priority to and the benefit of Korean Patent Application No. 10-2016-0015291 filed in the Korean Intellectual Property Office on Feb. 5, 2016, the entire contents of which are incorporated herein by reference.

### BACKGROUND OF THE INVENTION

(a) Field of the Invention

The present invention relates to a method for buffering a media transport stream in a heterogeneous network environment, and an image receiving apparatus using the same.

(b) Description of the Related Art

With the advent of digital broadcasting, a traditional broadcasting scheme in which viewers watch a signal transmitted unilaterally from a broadcasting station has been changed to a type in which a user can selectively view desired content at a desired time. Further, due to interworking with the Internet network, a user can use a bi-directional broadcasting service in which a user can send and receive interactive data while watching a broadcast.

Currently, the development of wideband transmission technology has realized a realistic broadcasting service capable of providing high-quality immersive media of 4K or more to viewers while overcoming bandwidth limitations. Also, as high-definition video services such as digital broadcasting and the Internet have become more common, ultra high definition (UHD) video has emerged as a new service, and technology development for a three-dimensional (3D) television broadcasting service based on UHD is under way. As reflected, the Advanced Television System Committee (ATSC) is working on standardization for a 4K UHD broadcasting service. However, in order to transmit 3D contents while maintaining compatibility with the 4K UHD broadcasting service through a broadcasting network, a 3DTV broadcasting sub-service that combines separate channels is being standardized because more bandwidth is required than with two-dimensional (2D) TV.

In addition, efforts are being made to provide immersive services to viewers through a heterogeneous network. However, the 3D content or the interlocking content (e.g., content reproduced by linking a specific program transmitted through an A network and content transmitted through a B network) transmitted through the hybrid network arrives at different times according to a type of receiver. That is, due to different transmission delays, a stream arriving later must be buffered for a predetermined time in a receiver prior to another stream arriving in order to provide a stable service.

Techniques related to this buffering include “Image receiving apparatus for providing hybrid service based on a transport stream system target decoder model” disclosed in Korean Patent Publication No. 2015-0045869. In this technique, in order to reproduce a 3D video by synchronizing a stream transmitted from a broadcasting network and a stream transmitted from the Internet network, a hybrid buffer is proposed in which a transport stream of a broadcasting network is buffered for a time. However, since this technique does not specifically suggest the time and method for hybrid buffering, a more clear transport stream buffering method is required.

Meanwhile, in order to expand broadcasting access to hearing-impaired people and to enhance the viewing environment of general viewers, a smart sign language broadcast in which a broadcasting image and a sign language image are respectively provided through the broadcasting network and the Internet network, wherein a receiver synchronizes and reproduces them, has been established as a national standard. In this standard, a recommendation is proposed to buffer the stream transmitted through the broadcasting network for about 10 seconds in order to synchronize streams transmitted through the broadcasting network and the Internet network. As such, since streams transmitted through different hybrid networks have different transmission delays caused by the configuration of the transmission/reception system and the network characteristics, a method is required to resolve the delays.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a buffering method and an image receiving apparatus using the method for stable synchronization and playback of various media streams received through different network paths.

An exemplary embodiment of the present invention provides a method of buffering transport streams received through different network paths. The method includes: receiving a first transport stream corresponding to a first image through a first network; receiving a second transport stream corresponding to a second image through a second network; buffering the first image corresponding to the first transport stream based on a preset minimum transmission delay difference; and processing the buffered first image and the second image corresponding to the second transport stream, wherein the minimum transmission delay difference corresponds to a delay excluding a delay occurring in an encoding process for transmission of the first image and the second image among delays generated in a transmission process of the first image and the second image.

The first image may be a reference image serving as a reference for reproduction, and the second image may be supplementary information or data that is reproduced in conjunction with the reference image. The minimum transmission delay difference may be determined based on a segment duration of the additional image processed and transmitted as a segment, and a minimum segment buffering time predetermined in accordance with a communication processing standard.

The minimum transmission delay difference may be determined by further considering a segment window size, an additional image segment transmission time, and a reference image transport stream transmission time. The minimum transmission delay difference may satisfy a condition of ΔT=(iS_{d}+I_{R}+MinbufferTime)−B_{R}), where ΔT may represent the minimum transmission delay difference, S_{d} may represents the segment duration of the additional image, i may represent the segment window size, I_{R} may represent the additional image segment transmission time, MinbufferTime may represent the minimum segment buffering time, and B_{R} may represent the reference image transport stream transmission time.

The first network may be a broadcast network and the second network may be an Internet network. Another exemplary embodiment of the present invention provides an image receiving apparatus for buffering transport streams received through different network paths.

The image receiving apparatus includes: a first receiver for receiving a first transport stream corresponding to a first image through a first network; a second receiver for receiving a second transport stream corresponding to a second image through a second network; and a processer for processing and reproducing the first image and the second image, wherein the first receiver includes a buffer for buffering a first video corresponding to the first transport stream based on a preset minimum transmission delay difference, and the minimum transmission delay difference corresponds to a delay excluding a delay occurring in an encoding process for transmission of the first image and the second image among delays generated in a transmission process of the first image and the second image.

The first image may be a reference image serving as a reference for reproduction, and the second image may be supplementary information or data that is reproduced in conjunction with the reference image.

In the image receiving apparatus, the minimum transmission delay difference may be determined based on a segment duration of the additional image processed and transmitted as a segment, and a minimum segment buffering time predetermined in accordance with a communication processing standard.

The minimum transmission delay difference may be determined by further considering a segment window size, an additional image segment transmission time, and a reference image transport stream transmission time. The minimum transmission delay difference may satisfy a condition of ΔT=(iS_{d}+I_{R}+MinbufferTime)−(B_{R}), where ΔT may represent the minimum transmission delay difference, S_{d} may represents the segment duration of the additional image, i may represent the segment window size, I_{R} may represent the additional image segment transmission time, MinbufferTime may represent the minimum segment buffering time, and B_{R} may represent the reference image transport stream transmission time.

The first receiver may further include a decoder for decoding the first image, which is buffered in the buffer and then is output, and outputting the decoded first image to the processer, and the second receiver may include a decoder for decoding the second image corresponding to the received second transport stream and outputting the decoded second image to the processer.

According to an embodiment of the present invention, it is possible to compensate for delay differences according to transmission environments in various hybrid service environments that are provided based on heterogeneous networks. Therefore, each of the transport streams received through the heterogeneous networks in the image receiving apparatus can be stably processed and reproduced, and a stable service can be provided.

### BRIEF DESCRIPTION OF THE DRAWINGS

FIG. 1 shows an example of an environment in which a stream is transmitted through a heterogeneous network.

FIG. 2 shows example of delays required by a transmitting/receiving process for images and each sub-process.

FIG. 3 shows an example of delays required by a transmitting/receiving process for additional images and each sub-process.

FIG. 4 a shows a schematic structural diagram of an image receiving apparatus according to an exemplary embodiment of the present invention.

FIG. 5 snows a flowchart of a method for buffering a transport stream according to an embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the specification, in addition, unless explicitly described to the contrary, the word “comprise” and variations such as “comprises” or “comprising” will be understood to imply the inclusion of stated elements but not the exclusion of any other elements.

Hereinafter, referring to drawings, a method for buffering a media transport stream in a heterogeneous network environment and an image receiving apparatus using the method will be described.

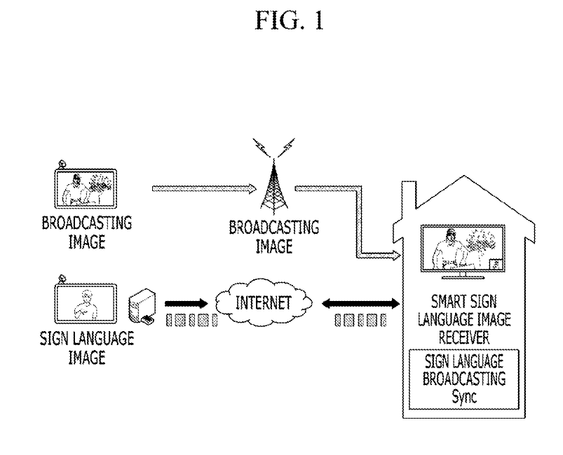

FIG. 1 shows an example of an environment in which a stream is transmitted through a heterogeneous network.

As exemplary shown in FIG. 1, a broadcasting image is transmitted through a broadcasting network, a sign language image is transmitted through the Internet, and then a receiver receives the broadcasting image and the sign language image and synchronizes and displays them. For this display process, a stream corresponding to the broadcasting image transmitted through the broadcasting network is buffered for a predetermined time, for example, about 10 seconds. The streams transmitted through the heterogeneous networks have different transmission delays due to the constructions of transmitting/receiving systems and the network characteristics.

Exemplary embodiments of the present invention provide a specific method for performing buffering based on transmission delays of streams transmitted through the broadcasting network and the Internet.

In an exemplary embodiment of the present invention, a stream applied to the broadcasting network is a Moving Pictures Experts Group-2 (MPEG-2) Transport Stream (TS), a Real-time Object Delivery over Unidirectional Transport (ROTUE) TS, or an MPEG Media Transport Protocol (MMTP) TS. The ROUTE and the MMTP represent a multiplexing standard for transport streams that is currently under a standardization process in Advanced Television Systems Committee (ATSC) 3.0. Also, the transport streams transmitted to the Internet follow the MPEG Dynamic Adaptive Streaming over Hypertext Transfer Protocol (MPEG-DASH) standard. However, the present invention may not be limited thereto.

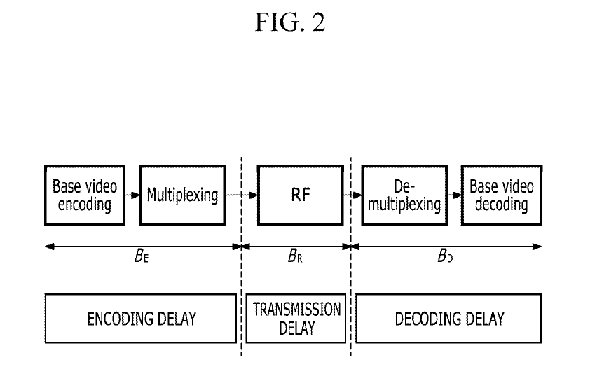

FIG. 2 shows example of delays required by a transmitting/receiving process for images and each sub-process.

An image used for reference in displaying will be referred to as a reference image, and the broadcasting image may be the reference image.

As shown in FIG. 2, the reference image, for example, a broadcasting image, is processed with image encoding (or video encoding), multiplexed, and then transmitted through a broadcasting network. The stream of the broadcasting image transmitted through the broadcasting network is received, de-multiplexed, image-decoded (or video decoded), and then reproduced as a broadcasting image by a receiver.

It is assumed that each delay generated in the encoding and multiplexing, the transmitting through the broadcasting network, and the de-multiplexing and decoding is B_{E}, B_{R}, and B_{D}. The total transmission delay B_{Total} that is required from the encoding of the reference image to the decoding may be defined as follows.

B_{Total}=B_{E}+B_{R}+B_{D} (Equation 1)

Here, the B_{E} represents a delay generated when encoding and decoding a reference image (in a process of signaling and stream multiplexing). B_{R} represents a transmission delay through the broadcasting network. B_{D} represents a delay generated when decoding the reference image and system decoding (in a process of de-multiplexing a multiplexed stream).

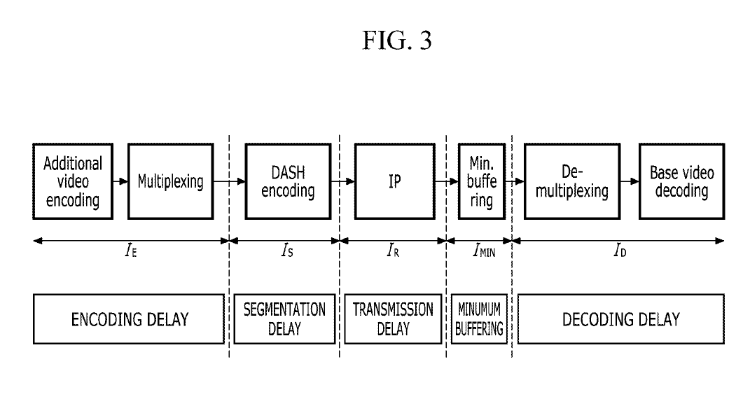

FIG. 3 shows an example of delays required by a transmitting/receiving process for additional images and each sub-process.

An additional image represents supplementary information or data which is reproduced in conjunction with the reference image. For example, in smart sign language broadcasting, a stream transmitted to a broadcasting network is used as the reference image and a stream transmitted to the Internet is used as the additional image.

As shown in FIG. 3, the additional image is processed by image encoding and multiplexing, divided into a plurality of segments according to Dynamic Adaptive Streaming over Hypertext Transfer Protocol (DASH) encoding, and then transmitted through, for example, the Internet. The segments of the additional image are received by a receiver. After that, they are buffered, de-multiplexed, decoded, and then reproduced as the additional image.

As above, for transmitting the additional image, compared to a process of transmitting/receiving a reference image, a DASH encoding process for generating segments according to an MPEG-DASH standard and a buffering process required for segments which are transmitted through the Internet are added. Accordingly, compared to transmitting/receiving a reference image, additional system delays occur.

If a delay in the encoding and multiplexing, a delay in the DASH encoding, a delay in the transmitting through a broadcasting network, and a delay in the buffering, de-multiplexing, and decoding are I_{E}, I_{S}, I_{R}, and I_{MIN}, respectively, the total transmission delay (I_{Total}) required from the encoding of the additional image to the decoding may be defined as follows.

I_{Total}=I_{E}+I_{S}+I_{R}+I_{MIN}+I_{D} (Equation 2)

Here, more specifically, I_{E} represents a delay in encoding and system encoding for an additional image. I_{S} represents a segmentation delay when generating an MPEG-2 DASH-based additional image and a media presentation description (MPD). I_{R} represents a delay in transmitting additional image segments through the Internet. I_{MIN} represents a minimum delay required in buffering additional image segments in a receiver. I_{D} represents a delay in decoding and system decoding an additional image.

If it is assumed that the delays in encoding, system encoding, system decoding, and decoding a reference image are equal to the delays in encoding, system encoding, system decoding, and decoding an additional image, a transmission delay difference (ΔT) through a heterogeneous network may be represented as follows.

ΔT=(I_{S}+I_{R}+I_{MIN})−(B_{R}) (Equation 3)

Here, I_{S} is a time to generate MPEG-DASH-based additional image segments and the MPD, and varies according to a minimum segment duration required for transmitting segments stably. Also, I_{R} corresponds to a delay in transmitting an additional image segment through the Internet, and represents a time to transmit an additional image segment requested by a receiver.

If a time to request and receive an MPD by a receiver for additional image segment transmission is I_{MPD}, Equation 3 may be represented as follows.

ΔT=(iS_{d}+α+I_{MPD}+I_{R}+I_{MIN})−(B_{R}) (Equation 4)

Here, S_{d} represents an actual segment duration of an additional image, and i represents a size of a segment window that is a duration for generating and transmitting a segment. α represents a time to generate segments and an MPD, and I_{MPD} represents a time to request and receive an MPD by a receiver.

If it is assumed that α and I_{MPD} are ‘0’, a time ΔT (may be called a minimum transmission delay difference) for buffering a transport stream in a broadcasting network may be defined as follows.

ΔT=(iS_{d}+I_{R}+MinbufferTime)−(B_{R}) (Equation 5)

Here, MinbufferTime represents I_{MIN}.

If it is possible to generate a segment and an MPD and transmit the segment stably according to a request of a receiver based on the actual segment duration S_{d}, i (the size of the segment window) is set as ‘1’. However, i may increase in order to transmit a segment stably according to an experimental environment and a service type.

The actual segment duration S_{d} is described in an MPD of an MPEG-DASH standard and represents actual segment duration information. For example, S_{d}=1 (s), which means that a segment consists of a one second stream.

Further, MinbufferTime is also described in an MPD of an MPEG-DASH standard and represents a minimum segment buffering time in a receiver. The receive needs to perform buffering for the MinbufferTime described in the MPD. Generally, a required minimum segment buffering time is lower than the MinbufferTime described in the MPD. That is, the required minimum segment buffering time varies according to a transmission bandwidth and a rate for additional image encoding. If a 10M encoded stream (S_{d}=1 second) is transmission of a 10M bandwidth, a required minimum MinbufferTime is 1 second. If a 3M encoded stream (S_{d}=1 second) is transmission of a 10M bandwidth, a required minimum MinbufferTime is 330 ms.

Accordingly, a transmission delay difference generated through a hybrid network varies according to a bandwidth situation of the Internet. However, the transmission delay difference is determined based on the additional image segment duration S_{d} and the minimum segment buffering time (MinbufferTime, I_{MIN}). Also, as in Equation 5, the transmission delay difference is determined based on the additional image segment duration S_{d}, the size of the segment window for stable transmission/reception (i), the additional image segment transmission time I_{R}, the minimum segment buffering time (MinbufferTime, I_{MIN}), and the time B_{R} to transmit a transport stream of a reference image.

Therefore, the related media can be stably reproduced by having the buffering time equal to the minimum transmission delay difference, that is, the minimum ΔT, except for the delay occurring in the encoding process of the reference image and the additional image.

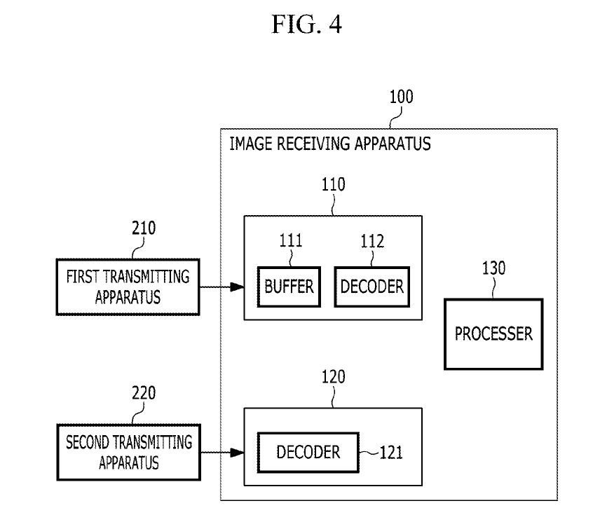

FIG. 4 shows a configuration diagram of an image receiving apparatus according to an exemplary embodiment of the present invention.

The image receiving apparatus 100 according to an exemplary embodiment of the present invention, as shown in FIG. 4, includes a first receiver 110, a second receiver 120, and a processor 130. The image receiving apparatus 100 may receive a hybrid transport stream through different paths, for example, a broadcasting network and an Internet network. Here, the hybrid transport stream may include a program having audio and video coded based on MPEG-2.

The first receiver 110 receives and processes a reference image through a first network (e.g., a broadcasting network), and the second receiver 120 receives an additional image through a second network (e.g., the Internet). The reference image is image encoded and multiplexed, and then transmitted through the first network, that is, the broadcasting network, by a first transmitting apparatus 210. The additional image is image encoded, multiplexed, DASH-encoded, and then transmitted through the first network, that is, the Internet network, by a second transmitting apparatus 220. The reference image and the additional image may correspond to the same 3D TV contents.

The first receiver 110 specifically includes a first buffer 111 and a decoder 112 for decoding the reference image output from the first buffer 111. The first buffer 111 buffers the reference image for a minimum ΔT to compensate for the transmission delay difference generated through the hybrid network and then outputs the buffered reference image. The minimum ΔT is determined based on the additional image segment duration S_{d} and the minimum segment buffering time (MinbufferTime, I_{MIN}). In addition, the minimum ΔT may be determined by further considering the size of the segment window for stable transmission/reception (i), the additional image segment transmission time I_{R}, and the reference image segment transmission time B_{R}.

The decoder 112 decodes the reference image from the first buffer 111. For this decoding, a buffer for storing a reference image, for example, an elementary stream corresponding to the reference image, an audio stream corresponding to the reference image, synchronization information for synchronization, and the like may be further included.

The second receiver 120 includes a decoder 121 for decoding the additional image. The decoder 121 decodes the additional image and may include a buffer for storing the additional image, for example, an elementary stream corresponding to the additional image, synchronization information for synchronization, and the like, for the decoding.

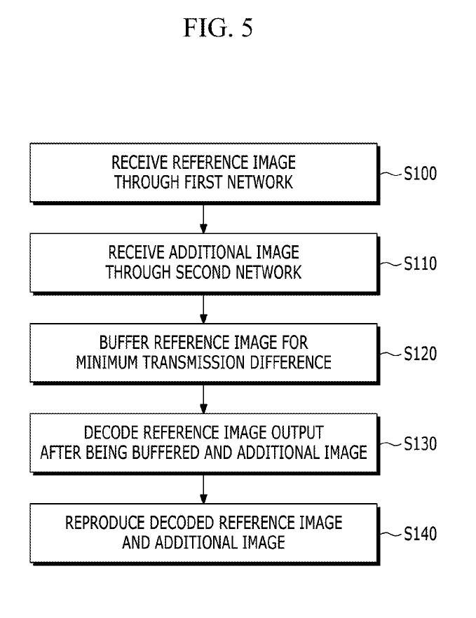

FIG. 5 shows a flowchart of a method for buffering a transport stream according to an exemplary embodiment of the present invention.

The first transmitting apparatus 210 encodes and multiplexes the reference image and then transmits the encoded and multiplexed reference image through a first network (e.g., a broadcasting network). The second transmitting apparatus 220 encodes, multiplexes, DASH encodes, and transmits the additional image to a second network (e.g., the Internet).

The image receiving apparatus 100 receives a transport stream corresponding to the reference image and the additional image, respectively (S100 and S110).

After that, the image receiving apparatus 100 buffers the received reference image by a predetermined minimum ΔT to compensate for the transmission delay difference generated through the hybrid network (S120).

The image receiving apparatus 100 decodes the reference image output after being buffered, and decodes the received additional image (S130).

Thereafter, the decoded reference image and the additional image are reproduced in synchronization with each other (S140).

The above-described embodiments can be realized through a program for realizing functions corresponding to the configuration of the embodiments or a recording medium for recording the program in addition to through the above-described device and/or method, which is easily realized by a person skilled in the art. While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of buffering transport streams received through different network paths, comprising:
receiving a first transport stream corresponding to a first image through a first network;
receiving a second transport stream corresponding to a second image through a second network;
buffering the first image corresponding to the first transport stream based on a preset minimum transmission delay difference; and
processing the buffered first image and the second image corresponding to the second transport stream,
wherein the minimum transmission delay difference corresponds to a delay excluding a delay occurring in an encoding process for transmission of the first image and the second image among delays generated in a transmission process of the first image and the second image.

2. The method of claim 1, wherein the first image is a reference image serving as a reference for reproduction, and the second image is supplementary information or data that is reproduced in conjunction with the reference image.

3. The method of claim 2, wherein the minimum transmission delay difference is determined based on a segment duration of the additional image processed and transmitted as a segment, and a minimum segment buffering time predetermined in accordance with a communication processing standard.

4. The method of claim 3, wherein the minimum transmission delay difference is determined by further considering a segment window size, an additional image segment transmission time, and a reference image transport stream transmission time.

5. The method of claim 4, wherein the minimum transmission delay difference satisfies a condition of ΔT=(iS_{d}+I_{R}+MinbufferTime)−(B_{R}), where
ΔT represents the minimum transmission delay difference, S_{d} represents the segment duration of the additional image, i represents the segment window size, I_{R} represents the additional image segment transmission time, MinbufferTime represents the minimum segment buffering time, and B_{R} represents the reference image transport stream transmission time.

6. The method of claim 1, wherein the first network is a broadcast network and the second network is an Internet network.

7. An image receiving apparatus for buffering transport streams received through different network paths, comprising:
a first receiver for receiving a first transport stream corresponding to a first image through a first network;
a second receiver for receiving a second transport stream corresponding to a second image through a second network; and
a processer for processing and reproducing the first image and the second image,
wherein the first receiver comprises
a buffer for buffering a first video corresponding to the first transport stream based on a preset minimum transmission delay difference, and
the minimum transmission delay difference corresponds to a delay excluding a delay occurring in an encoding process for transmission of the first image and the second image among delays generated in a transmission process of the first image and the second image.

8. The image receiving apparatus of claim 7, wherein the first image is a reference image serving as a reference for reproduction, and the second image is supplementary information or data that is reproduced in conjunction with the reference image.

9. The image receiving apparatus of claim 8, wherein the minimum transmission delay difference is determined based on a segment duration of the additional image processed and transmitted as a segment, and a minimum segment buffering time predetermined in accordance with a communication processing standard.

10. The image receiving apparatus of claim 9, wherein the minimum transmission delay difference is determined by further considering a segment window size, an additional image segment transmission time, and a reference image transport stream transmission time.

11. The image receiving apparatus of claim 10, wherein the minimum transmission delay difference satisfies a condition of ΔT=(iS_{d}+I_{R}+MinbufferTime)−(B_{R}), where
ΔT represents the minimum transmission delay difference, S_{d} represents the segment duration of the additional image, i represents the segment window size, I_{R} represents the additional image segment transmission time, MinbufferTime represents the minimum segment buffering time, and B_{R} represents the reference image transport stream transmission time.

12. The image receiving apparatus of claim 7, wherein the first receiver further comprises a decoder for decoding the first image, which is buffered in the buffer and then is output, and outputting the decoded first image to the processer, and
the second receiver comprises a decoder for decoding the second image corresponding to the received second transport stream and outputting the decoded second image to the processer.
